(19) United States
(12) Patent Application Publication
(10) Pub. No.: US 2003/0031010 A1
(43) Pub. Date: Feb. 13, 2003

(54) Led lamp in minifuse shaped housing

(76) Inventors: Krzysztof Sosniak, Wallington, NJ (US); Peter Murphy, Kearny, NJ (US)

Correspondence Address: OSTROLENK FABER GERB & SOFFEN, 1180 AVENUE OF THE AMERICAS, NEW YORK, NY, 100368403

(21) Appl. No.: 10/215,489

(22) Filed: Aug. 8, 2002

Related U.S. Application Data
(60) Provisional application No. 60/311,145, filed on Aug. 9, 2001.

(51) Int. Cl. F21V 33/00

(52) U.S. Cl. 362/140; 362/231; 362/800

(57) ABSTRACT

An LED circuit is packaged in a minifuse container to provide illumination or indication in applications using minifuse receptacles. One such application is a vanity mirror for an automobile that has minifuse receptacles around the mirror to provide illumination to the mirror. Rather than incandescent light components in the minifuse receptacles, the LED circuit provides illumination that has a natural appearance, with low power consumption and low heat. The LED circuit combines a red and white LED to produce a natural illumination light. The white LED has a coating of phosphor to enhance the natural light illumination. The LED circuit can be used in other minifuse type receptacles, such as a fuse box, to function as a fuse and to indicate fuse or circuit status. The circuit is compact, versatile, consumes little power and can have additional functionality beyond a fuse or an incandescent lamp.

### RELATED APPLICATION

This application is based on and claims benefit of U.S. Provisional Application Serial No. 60/311,145, filed Aug. 9, 2001 entitled LED RAY LAMP IN MINIFUSE SHAPED HOUSING, to which a claim of priority is hereby made.

### BACKGROUND OF THE INVENTION

1. Field of the Invention

The present invention relates generally to a small package LED array, and more particularly to an LED array in a minifuse shaped housing. The invention has several applications because of the variable size and the shape of the housing.

2. Description of Related Art

A typical vanity mirror is equipped with two fuse size incandescent bulbs, each located in a respective cavity in a housing of the vanity mirror on opposite sides of the mirror. The bulbs are relatively high consumers of electric power and radiate large amounts of heat when operated. In addition, when used in a vanity mirror, incandescent bulbs produce a light that can be considered glaring or unnatural in character. The above characteristics are undesirable in a vanity mirror.

One approach to solving the above problems involves using an alternate light source for the vanity mirror which does not have the fuse type outline. Such a substitution can solve the above problems, but involves providing appropriate and modified circuitry to operate the alternate light source, since the electrical characteristics of the light source will typically be different. Further, a modified support for the lamps would be needed. However, the support for the circuit provided to power the bulbs in a typical vanity mirror for an automobile is produced using a multi-staged stamping tool. The tool requires a high capital investment, especially for automotive producers and producers of automobile visors with illuminated vanity mirrors. Such an investment to make the change to a non-critical automotive function is prohibitive. Accordingly, there is a need for an alternate light source for a vanity mirror that can solve the drawbacks of conventional incandescent bulbs, while acting as a simple and easy substitute in existing circuitry supports produced by already purchased stamping tools.

### SUMMARY OF THE INVENTION

According to the present invention, rather than incandescent lamps, LED based lamps are provided. One application for the invention is to incorporate LED based lighting in vanity mirrors which limits the time and expense of installation of the lighting. In a vanity mirror embodiment, for example, the fuse body shaped LED lamp is shaped and sized so it can fit in the cavities in the vanity mirror housing without need for circuit or receptacle redesign. The LED based lamps can replace the incandescent lamps while using the current tools and circuitry provided for the production of illuminated vanity mirrors.

The fuse-shaped LED lamp can be made to contain appropriate circuitry for using the power already supplied to the vanity mirror lighting receptacles. Connectors or contacts or ferrules are supplied on ends of the LED lamp to provide appropriate electrical connections between the LED lamp and the existing receptacles. The LED lamps use substantially less power than incandescent bulbs, and generate very little heat. In addition, the LEDs used in the lamp can be selected or manufactured to provide a natural-like lighting output when operated.

For example, a combination of white and red LEDs produces an aesthetically appealing natural-like light output. The LED lamp device can also incorporate current limiting devices to prolong lamp life and permit other applications for the LED lamp.

Another application for the invention is in the fuse harness of an automotive vehicle, where an additional circuit in the harness may be connected with a fuse shaped body. Other related applications involve providing a fuse body with a shape and size suitable for a particular illumination application. The fuse body can be used along with several other fuses or other electrical apparatus for an apparatus that requires illumination.

### BRIEF DESCRIPTION OF THE DRAWINGS

The present invention is described below in detail with reference to the drawings in which:

FIG. 1 is a side perspective drawing according to the present invention;

FIG. 2 is a plan perspective drawing according to the present invention;

FIG. 3 is an illustration of a vanity mirror; and

FIG. 4 is an illustration of a fuse array.

### DETAILED DESCRIPTION OF THE PREFERRED EMBODIMENTS

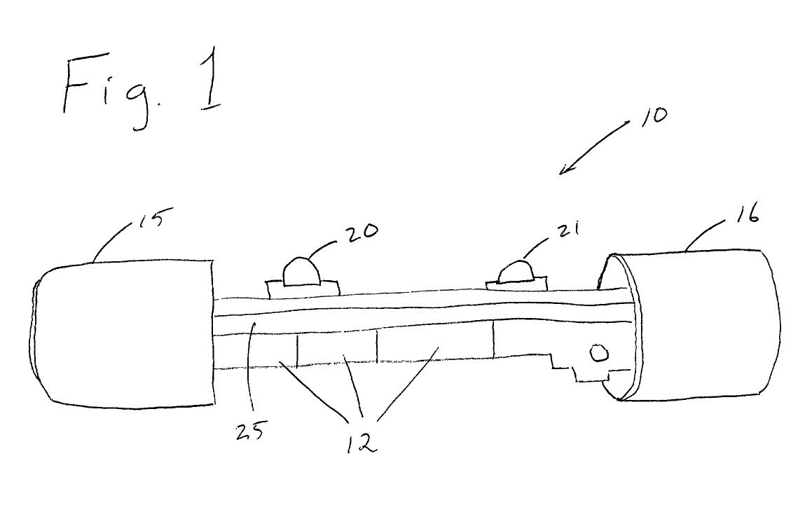

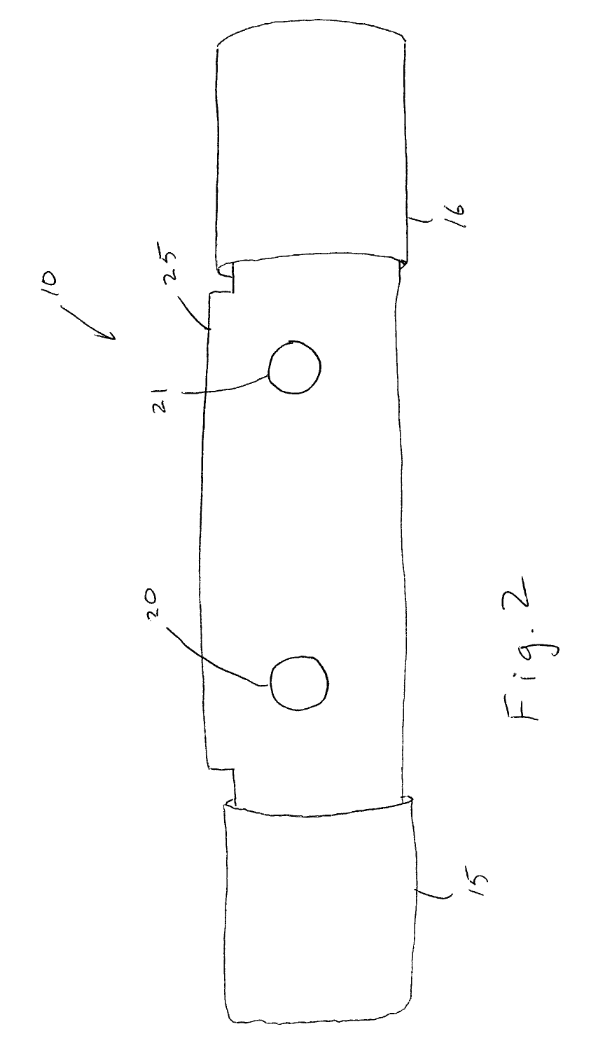

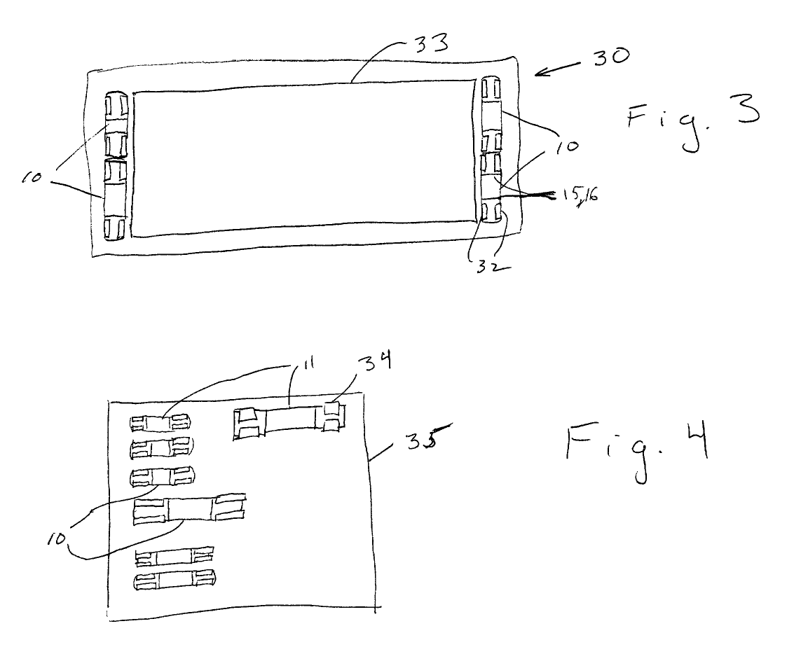

Referring now to FIGS. 1 and 2, a minifuse body lamp 10 has two light emitting diodes (LED) 20, 21 disposed on a circuit board 25. LED 20 is white and LED 21 is red. White and red LEDs 20, 21 have a combined output for use for producing a preferred natural white light. White LED 20 may be covered with an appropriate phosphor to produce a desired quality of light that, when combined with the light from red LED 21, produces a natural color of illumination. The light produced by the combination of white LED 20 and red LED 21 is especially valuable for a vanity mirror, as illustrated in FIG. 3.

A selected number of LEDs 20, 21 are disposed on circuit board 25 of lamp 10 to provide the desired intensity and color light. Since the light from LEDs 20, 21 is directional, the LEDs 20, 21 on circuit board 25 produce light efficiently from the electrical energy supplied. The position of the LEDs 20, 21 can be adjusted to provide a desired color overlap output of light. The separate LEDs 20, 21 can also have different light intensities, through selection of the LED 20, 21 or through the circuitry supplying power to the LEDs 20, 21. In addition, a cover can be placed over the LEDs 20, 21 to diffuse or focus the light output and provide selected lighting characteristics. The selection of desired lighting characteristics can include diffusion of light output, refracted or reflected light output, and so forth. Characteristics such as reduced eye strain or flattering appearance can be achieved by modifying the light output as desired.

Moreover, the lamp 10 can be mounted in any desired location regarding use with a vanity mirror. For example, the lamp 10 may be located behind a partially silvered mirror surface to project light through the mirror. A further mirror surface may be placed behind the lamp to further project light towards a vanity mirror. The lamp 10 can also be mounted away from the mirror to provide a wedge shaped lighting output to focus light toward a given region.

A circuit on circuit board 25 can include a number of components such as switches, capacitors, resistors and appropriate current limiting devices. The circuit can be configured according to known techniques to provide desired operation, such as hot-plugging, extended life and so forth. Circuit board 25 is physically supported in opposing spaced apart end caps 15, 16 with a contact from circuit board 25 contacting conductive end caps 15, 16. According to the present invention, end caps 15, 16 need not be supplied with the circuit board 25. It should be apparent that circuit board 25 can be provided with any type of contacts suitable for use in minifuse-type receptacles, as long as electric power can flow through the receptacles to the contacts.

When inserted into a minifuse-type receptacle, end caps 15, 16 are each connected into an electric circuit for supplying power to circuit board 25. On circuit board 25 between the end caps, LEDs 20, 21 are exposed. A cylindrical transparent or translucent covering (not shown), shaped like a fuse housing used in fuse or small lamp applications, may be disposed around circuit board 25. The covering can provide additional rigidity to lamp 10, in addition to serving as a protective cover, or sealant for lamp 10. The covering can also provide light filtering and directing features, as discussed above.

The size of the entire housing comprised of end caps 15, 16 and the transparent or translucent light LED covering around the board is selected for the particular application and to match the size of light bulbs placed in cavities in vanity mirrors, the size of fuses in an array with which the lamp is used or the size of any other related component for which the lamp is used.

Referring to FIG. 3, a vanity mirror is shown with an arrangement of lamps 10. Each lamp 10 is attached to vanity mirror 30 with spring clips 32 shaped to receive end caps 15, 16. Spring clips 32 are connected to an electrical circuit (not shown) to supply power to lamps 10, and illuminate mirror 33.

Referring to FIG. 4, an array 35 of fuses 11 in fuse holders 34 is shown. According to the present invention, and as indicated in FIG. 4, lamps 10 may be used in array 35 and configured to operate as a fuse or current limiting device. Lamps 10 can indicate by remaining lit that the fuse has not been blown. Alternatively, lamp 10 can include a switch that can be actuated to provide power to LED 20, for example, to provide a switchable indication to determine when the fuse is intact. Such a configuration would provide a visible test, actuated through the switch, to determine the working status of the fuse-lamp.

In another embodiment, lamp 10 can be configured to turn on when it has a fuse connection blown, to indicate a non-working state. Such an indication would be useful for quickly identifying and replacing malfunctioning parts or components.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A circuit for use in a minifuse receptacle, comprising:
a circuit board structure having electrical conductors and having a long dimension sized to be accommodated in a minifuse receptacle, the circuit board structure having opposed first and second ends along the long dimension;
a conductive end piece on each of the first and second ends for contacting connectors in the minifuse receptacle, the end pieces each being electrically connected to one of the electrical conductors in the circuit board structure;
an LED on the circuit board structure and electrically coupled with one of the electrical conductors in the circuit board structure; and
the LED is illuminated when electric power is applied to the circuit.

2. A circuit according to claim 1, further comprising a second LED electrically coupled with one of the electrical conductors, such that the second LED is illuminated when power is applied to the circuit.

3. The circuit according to claim 2, wherein one of the LEDs is white in color when illuminated, and the other LED is red in color when illuminated.

4. The circuit according to claim 3, wherein the white LED has a phosphor coating.

5. The circuit according to claim 3, wherein the colors produced by illumination of the two LEDs is adjusted to produce a natural lighting illumination.

6. The circuit according to claim 1, further comprising a cover surrounding the circuit structure and connected between the two end pieces.

7. The circuit according to claim 6, wherein the cover is at least one of transparent and translucent.

8. The circuit according to claim 7, wherein the cover has a desired color tint.

9. The circuit according to claim 6, wherein the cover forms a seal between the end pieces to sealably enclose the circuit board structure.

10. The circuit according to claim 1 in combination with a mirror structure, wherein the circuit provides illumination to the mirror structure when powered is applied to illuminate the LED.

11. The circuit according to claim 3 in combination with a mirror structure, wherein the circuit provides natural illumination to the mirror structure when powered is applied.

12. A vanity mirror, comprising:
a mirror within a mirror structure suitable for illumination;
a minifuse receptacle in the mirror structure for receiving a circuit having a size useable with the minifuse receptacle;
an illumination component having a size of a minifuse and suitable for placement in the minifuse receptacle;
the illumination component further comprising two LEDs for illuminating the mirror when power is applied to the illumination component; and
a switch connected between a power source and the illumination component to permit power to be selectively applied to the illumination component.

13. The vanity mirror according to claim 12, wherein one LED is white in color when illuminated, and the other LED is red in color when illuminated.
